(19) United States
(12) Patent Application Publication
(10) Pub. No.: US 2026/0049894 A1
(43) Pub. Date: Feb. 19, 2026

(54) LENS MEASURING METHOD AND LENS MEASURING DEVICE

(71) Applicant: Panasonic Intellectual Property Management Co., Ltd., Osaka (JP)

(72) Inventors: JUN YOKOYAMA, Osaka (JP); YASUHIRO KABETANI, Osaka (JP)

(21) Appl. No.: 19/322,662

(22) Filed: Sep. 8, 2025

Related U.S. Application Data
(63) Continuation of application No. PCT/JP2024/002314, filed on Jan. 26, 2024.

(30) Foreign Application Priority Data
Mar. 24, 2023 (JP) 2023-047680

(51) Int. Cl. G01M 11/02

(52) U.S. Cl. CPC G01M 11/025; G01M 11/0221

(57) ABSTRACT

A surface shape of first face (8a) of lens (8) is measured with shape measurement unit (2) to determine a center position of first face (8a) of lens (8) from a measurement result, lens (8) is positioned in transmission wavefront measurement unit (3) based on the center position of first face (8a) of lens (8) and a relative position between shape measurement unit (2) and transmission wavefront measurement unit (3), a transmission wavefront of lens (8) is measured with transmission wavefront measurement unit (3), and an optical characteristic of lens (8) is obtained from the transmission wavefront.

### TECHNICAL FIELD

The present disclosure relates to a lens measurement method and a lens measurement device for measuring optical characteristics of a lens.

### BACKGROUND ART

PTL 1 discloses a lens measurement method for measuring a shape error of front and back faces of a lens. In this lens measurement method, from a shape measurement result for the upper face (that is, a first face) and a shape measurement result for the lower face (that is, a second face) of an aspheric lens, the eccentricity amounts of the optical axes of the first face and the second face are obtained.

Here, a lens measurement method of PTL 1 will be described with reference to FIG. 11. FIG. 11 is a diagram schematically illustrating lens measurement device 101 disclosed in PTL 1.

Lens measurement device 101 includes optical probe 102 for measuring a shape, lens installation jig 104 for holding lens to be inspected 103, and camera 105. Optical probe 102 measures a displacement amount by a triangulation method, and laser light emitted from sensor unit 106 is incident on objective lens 108 via reflection mirror 107 and applied to a surface of lens to be inspected 103. The laser light reflected by the surface of lens to be inspected 103 is incident on objective lens 108 again, is detected by sensor unit 106 via reflection mirror 107, and the displacement amount is measured.

The measurement of lens to be inspected 103 is performed as follows.

Lens to be inspected 103 is installed on lens installation jig 104.

Next, lens installation jig 104 is scanned on the xy plane determined by the x axis and the y axis in FIG. 11, and the shape of the surface of first face 103a of lens to be inspected 103 is measured by optical probe 102. In addition, pinholes 109 and 110 provided in lens installation jig 104 are measured by camera 105 via reflection mirror 107 and objective lens 108, and the position of lens installation jig 104 on the xy plane at the time of measuring the first face of lens to be inspected 103 is obtained.

Next, lens installation jig 104 is installed in a vertically inverted manner, and the shape of second face 103b of lens to be inspected 103 is measured by optical probe 102 in the same manner. The position of lens installation jig 104 on the xy plane at the time of measuring the second face of lens to be inspected 103 is obtained in the same manner.

Finally, the eccentricity amounts of the optical axes of the first face and the second face can be obtained from each center position of the first face and the second face obtained from the shapes of the first face and the second face of lens to be inspected 103 and each position of lens installation jig 104 on the xy plane at the time of measuring the first face and the second face.

### CITATION LIST

### Patent Literature

PTL 1: International Publication No. WO 2007/018118

### SUMMARY OF THE INVENTION

A lens measurement method according to one aspect of the present disclosure is a lens measurement method using a shape measurement unit that measures a surface shape of a lens and a transmission wavefront measurement unit that measures a transmission wavefront of the lens, the method including:
measuring a surface shape of a first face of the lens with the shape measurement unit to determine a center position of the first face of the lens from a result of the measuring of the surface shape;
positioning the lens in the transmission wavefront measurement unit based on the center position of the first face of the lens and a relative position between the shape measurement unit and the transmission wavefront measurement unit;
measuring the transmission wavefront of the lens with the transmission wavefront measurement unit; and
obtaining an optical characteristic of the lens from a result of the measuring of the transmission wavefront.

A lens measurement device according to another aspect of the present disclosure includes:
a shape measurement unit that measures a surface shape of a first face of a lens;
a shape measurement calculation unit that determines a center position of the first face of the lens from a measurement result in the shape measurement unit;
a transmission wavefront measurement unit that measures a transmission wavefront of the lens that has been positioned based on a relative position with the shape measurement unit and the center position of the first face of the lens; and
a calculation unit that obtains an optical characteristic of the lens from a result of measuring the transmission wavefront of the lens with the transmission wavefront measurement unit.

### BRIEF DESCRIPTION OF THE DRAWINGS

FIG. 1 is a diagram schematically illustrating a lens measurement device according to an exemplary embodiment of the present disclosure.

FIG. 2 is a diagram schematically illustrating a relative position adjustment jig according to the exemplary embodiment of the present disclosure.

FIG. 3 is a flowchart describing a relative position adjustment method for the lens measurement device according to the exemplary embodiment of the present disclosure.

FIG. 4 is a diagram schematically illustrating a shape measurement unit in the relative position adjustment method for the lens measurement device according to the exemplary embodiment of the present disclosure.

FIG. 5 is a diagram schematically illustrating a relationship between the center of a reference sphere in the shape measurement unit and a reference position of the shape measurement unit in the relative position adjustment method for the lens measurement device according to the exemplary embodiment of the present disclosure.

FIG. 6 is a diagram schematically illustrating a transmission wavefront measurement unit in the relative position adjustment method for the lens measurement device according to the exemplary embodiment of the present disclosure.

FIG. 7 is a diagram schematically illustrating a relationship between the center of a projection image of the reference sphere in the transmission wavefront measurement unit and a reference position of the transmission wavefront measurement unit in the relative position adjustment method for the lens measurement device according to the exemplary embodiment of the present disclosure.

FIG. 8 is a flowchart describing a lens measurement method with the lens measurement device according to the exemplary embodiment of the present disclosure.

FIG. 9 is a diagram schematically illustrating a lens measurement device according to a modification of the exemplary embodiment of the present disclosure.

FIG. 10 is a diagram schematically illustrating the lens measurement device according to the modification of the exemplary embodiment of the present disclosure at the time of transmission wavefront measurement in the lens measurement device.

FIG. 11 is a diagram schematically illustrating a lens measurement device disclosed in PTL 1.

### DESCRIPTION OF EMBODIMENT

In the lens measurement method disclosed in PTL 1, it is necessary to measure the shape of the second face of lens to be inspected 103 by vertically inverting lens to be inspected 103 after measuring the shape of the first face of lens to be inspected 103, and thus, there is a problem that the measurement time becomes long.

An object of one aspect of the present disclosure is to provide a lens measurement method and a lens measurement device capable of shortening a time for measuring optical characteristics of a lens.

Hereinafter, an exemplary embodiment of the present disclosure will be described with reference to the drawings. The same reference numerals are given to the components common in the drawings, and the description thereof will be appropriately omitted.

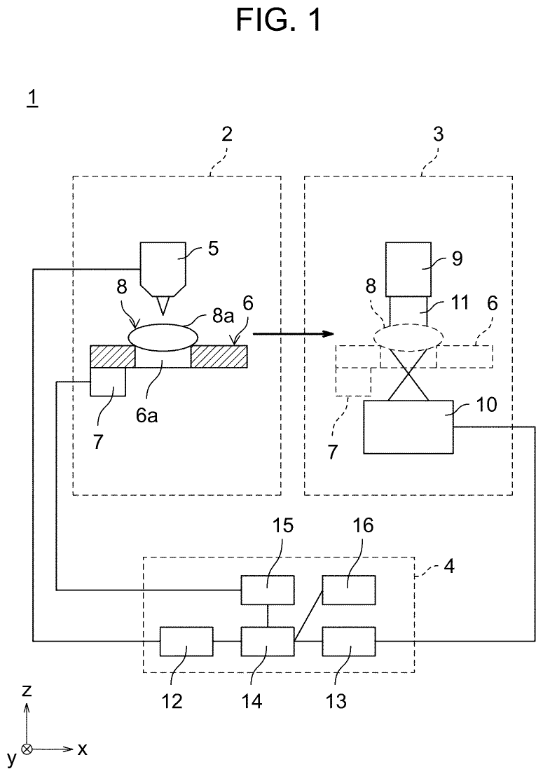

A representative example of a lens measurement device according to an exemplary embodiment of the present disclosure will be described with reference to FIG. 1. FIG. 1 is a diagram schematically illustrating lens measurement device 1 according to an exemplary embodiment of the present disclosure.

Lens measurement device 1 includes at least shape measurement unit 2, transmission wavefront measurement unit 3, and control device 4 including shape measurement calculation unit 12 and calculation unit 14.

Shape measurement unit 2 measures the surface shape of first face 8a of lens 8.

Shape measurement calculation unit 12 determines the center position of first face 8a of lens 8 from the measurement result of shape measurement unit 2.

Transmission wavefront measurement unit 3 measures the transmission wavefront of lens 8 positioned based on a relative position between transmission wavefront measurement unit 3 and shape measurement unit 2 and the center position of first face 8a of lens 8.

Calculation unit 14 obtains optical characteristics of lens 8 from the result of measuring the transmission wavefront of lens 8 with transmission wavefront measurement unit 3.

Hereinafter, these configurations will be described in detail.

Shape measurement unit 2 includes measurement probe 5, lens installation unit 6, and transfer unit 7, and lens to be inspected 8 is installed in lens installation unit 6.

Measurement probe 5 measures a three-dimensional shape of a measurement object such as lens to be inspected 8, and performs measurement by scanning in the x, y, and z-axis directions of FIG. 1. Measurement probe 5 uses a displacement measurement method of a contact type or a method such as triangulation or interference measurement using a laser.

Lens installation unit 6 is constituted by a frame body provided with opening 6a so that light incident on lens to be inspected 8 that has been installed can be transmitted.

Transfer unit 7 is, for example, an orthogonal robot that transfers lens installation unit 6 in an xy-axis direction. Transfer unit 7 enables lens installation unit 6 to move between the measurement position of shape measurement unit 2 and the measurement position of transmission wavefront measurement unit 3, and positions lens installation unit 6 at each of the measurement positions of shape measurement unit 2 and transmission wavefront measurement unit 3.

Transmission wavefront measurement unit 3 includes light source 9, wavefront sensor 10, lens installation unit 6 (illustrated by a dotted line) described in shape measurement unit 2, and transfer unit 7 (illustrated by a dotted line) described in shape measurement unit 2.

Here, wavefront sensor 10 is a sensor that directly measures the phase distribution of the wavefront of light, and for example, a Shack-Hartmann sensor using a microlens array, a Fizot interferometer, or a wavefront sensor using sharing interference by a diffraction grating is used. In the present exemplary embodiment, as an example, a wavefront sensor using sharing interference by a diffraction grating having a large dynamic range is used.

Light source 9 is a light source that emits parallel light 11, and in the present exemplary embodiment, a parallel light source having a wavelength of 635 nm is used as an example. The optical axis (z-axis direction in the drawing) of parallel light 11 is adjusted to be perpendicular to the installation face (xy-axis plane in the drawing) of lens to be inspected 8 of lens installation unit 6.

Control device 4 is a device that controls lens measurement device 1, and includes shape measurement calculation unit 12, transmission wavefront measurement calculation unit 13, calculation unit 14, controller 15, and relative position storage 16. Control device 4 may include, for example, a processor and a memory connected to the processor. The function of control device 4 described below may be realized by a processor executing a program stored in a memory.

Shape measurement calculation unit 12 calculates the three-dimensional shape of a measurement object by calculating the data measured with measurement probe 5.

Transmission wavefront measurement calculation unit 13 calculates a transmission wavefront by calculating data measured with wavefront sensor 10.

Calculation unit 14 controls control device 4, and performs various calculations and commands such as obtaining a relative position between shape measurement unit 2 and transmission wavefront measurement unit 3.

Controller 15 controls transfer unit 7 to position lens installation unit 6.

Relative position storage 16 stores the relative position between shape measurement unit 2 and transmission wavefront measurement unit 3.

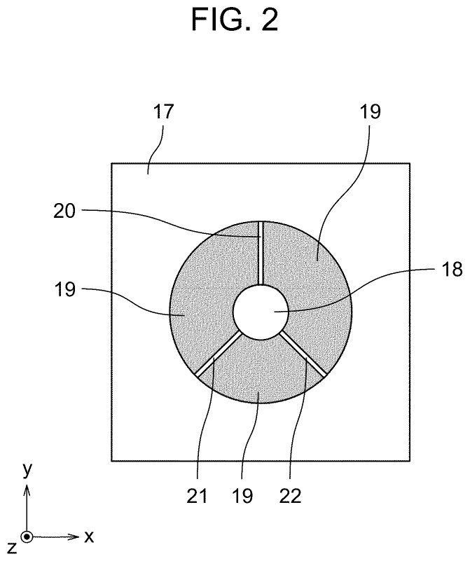

To obtain the relative position between shape measurement unit 2 and transmission wavefront measurement unit 3 of lens measurement device 1, relative position adjustment jig 17 that can be installed in lens installation unit 6 instead of lens 8 is used. FIG. 2 is a diagram schematically illustrating relative position adjustment jig 17 according to the exemplary embodiment of the present disclosure.

Relative position adjustment jig 17 includes reference sphere 18 as an example of a reference sphere unit, and opening 19 as an example of a light transmission unit that transmits light is provided around reference sphere 18. In the present exemplary embodiment, as an example, reference sphere 18 is fixed by three support rods 20, 21, and 22 disposed at equal angular intervals around reference sphere 18.

Opening 19 is not limited as long as it transmits light. For example, opening 19 may be made of glass that transmits light. In this case, support rods 20, 21, and 22 are unnecessary.

As reference sphere 18, a steel sphere, a ceramic sphere, or the like may be used, and the sphericity of the sphere is desirably less than or equal to 1 μm. This is because, as described later, the relative position between shape measurement unit 2 and transmission wavefront measurement unit 3 is obtained using the center position of reference sphere 18, and thus, high accuracy is required for the sphericity of reference sphere 18.

The diameter of reference sphere 18 is set to be smaller than each of the vertical dimension and the horizontal dimension of the image sensor of wavefront sensor 10. This is to enable wavefront sensor 10 to measure a projection image of reference sphere 18 as described later.

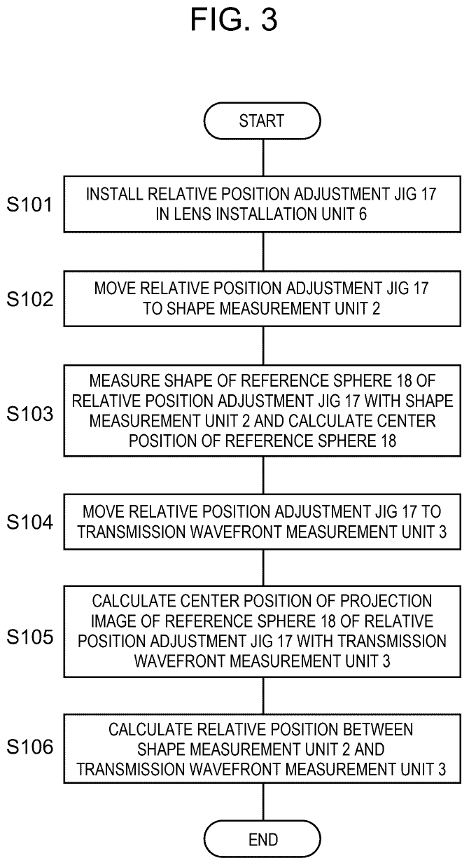

Next, a method for obtaining the relative position between shape measurement unit 2 and transmission wavefront measurement unit 3 of the measurement device I will be described in order with reference to the flowchart of FIG. 3. FIG. 3 is a flowchart describing a relative position adjustment method for lens measurement device 1 according to the exemplary embodiment of the present disclosure.

First, in step S101, relative position adjustment jig 17 is installed in lens installation unit 6 instead of installing lens to be inspected 8. At this time, relative position adjustment jig 17 is installed such that reference sphere 18 is disposed in opening 6a of lens installation unit 6.

Next, in step S102, relative position adjustment jig 17 is moved to shape measurement unit 2 by transfer unit 7 under the control of controller 15.

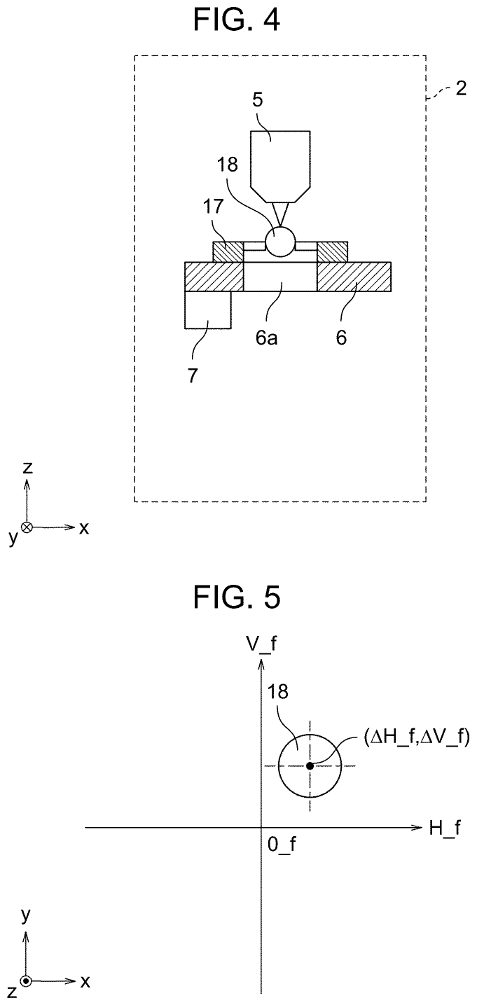

FIG. 4 is a diagram schematically illustrating shape measurement unit 2 in the relative position adjustment method for lens measurement device 1 according to the exemplary embodiment of the present disclosure. Relative position adjustment jig 17 is positioned at a predetermined reference position of shape measurement unit 2 by transfer unit 7 under the control of controller 15.

Next, in step S103, the shape of reference sphere 18 of relative position adjustment jig 17 is measured by shape measurement unit 2 with measurement probe 5, and the center position of reference sphere 18 is calculated by shape measurement calculation unit 12 based on the measurement result.

In the present exemplary embodiment, as an example, the vertex position of reference sphere 18 in a z-axis direction is obtained by shape measurement calculation unit 12 as the center position of reference sphere 18. The vertex position of reference sphere 18 in the z-axis direction can be obtained by, for example, measuring a section of reference sphere 18 in any x-axis direction with measurement probe 5, obtaining an x-coordinate at which a vertex comes in the z-axis direction with shape measurement calculation unit 12, measuring a section of reference sphere 18 in any y-axis direction, and obtaining a y-coordinate at which a vertex comes in the z-axis direction with shape measurement calculation unit 12, whereby the x and y coordinates of the center position of reference sphere 18 can be obtained with shape measurement calculation unit 12.

Instead of such a method, a method may be employed in which the vicinity of a vertex of reference sphere 18 is scanned on the xy-axis plane at equal intervals to obtain coordinates having a maximum value in the z-axis direction.

The relationship between the center position of reference sphere 18 and the predetermined reference position of shape measurement unit 2 will be described with reference to FIG. 5. FIG. 5 is a diagram schematically illustrating a relationship between the center of reference sphere 18 in shape measurement unit 2 and a reference position of shape measurement unit 2 in the relative position adjustment method for lens measurement device 1 according to the exemplary embodiment of the present disclosure.

The coordinate system of lens measurement device 1 is defined as x, y, and z axes, and the coordinate system of shape measurement unit 2 in a scanning direction is defined as H_f and V_f axes. To simplify the description, the x axis and the H_f axis, and the y axis and the V_f axis are oriented in the same direction. The origin position of shape measurement unit 2 is defined as O_f. The center position of reference sphere 18 described above is obtained as an amount of shift from origin position O_f of shape measurement unit 2. The center position of reference sphere 18 at this time is represented as coordinates (ΔH_f, ΔV_f) in the coordinate system of shape measurement unit 2. Assuming that the center position of reference sphere 18 at the reference position of shape measurement unit 2 is coordinates (Xf, Yf) in the coordinate system of lens measurement device 1, the coordinates (Xof, Yof) of origin position O_f of shape measurement unit 2 in the coordinate system of lens measurement device 1 can be expressed by Formulas (1) and (2).

$$Xof = Xf - ΔH\_f \qquad ( 1 )$$

$$Yof = Yf - ΔV\_f \qquad ( 2 )$$

Next, in step S104, relative position adjustment jig 17 is moved from shape measurement unit 2 to transmission wavefront measurement unit 3 by transfer unit 7 under the control of controller 15.

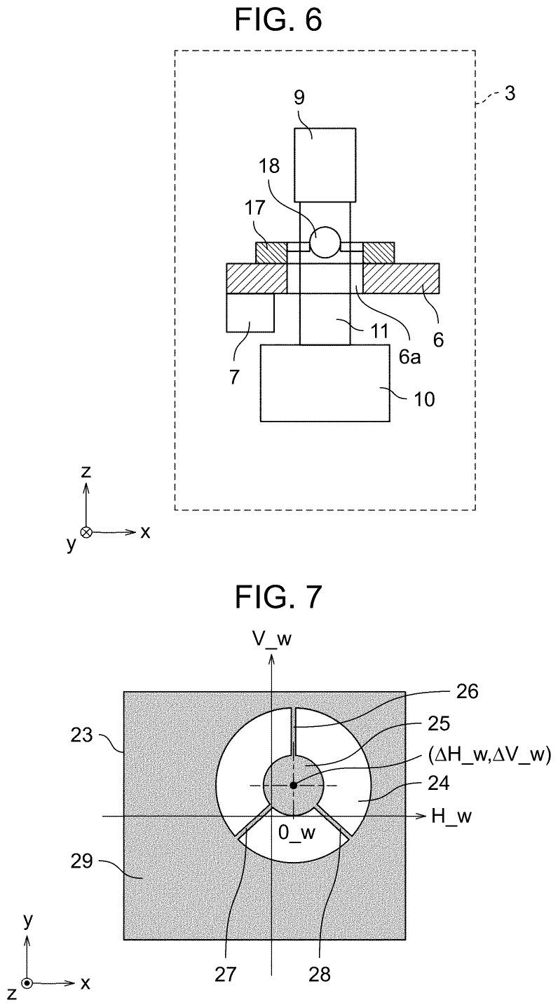

FIG. 6 is a diagram schematically illustrating transmission wavefront measurement unit 3 in the relative position adjustment method for lens measurement device 1 according to the exemplary embodiment of the present disclosure. Relative position adjustment jig 17 is positioned at a predetermined reference position of transmission wavefront measurement unit 3 by transfer unit 7 under the control of controller 15.

Next, in step S105, a projection image of reference sphere 18 of relative position adjustment jig 17 is measured by transmission wavefront measurement unit 3, and the center position of the projection image is calculated by transmission wavefront measurement calculation unit 13 based on the measurement result.

That is, in FIG. 6, in transmission wavefront measurement unit 3, parallel light 11 is emitted from light source 9, and the light transmitted through relative position adjustment jig 17 is measured by wavefront sensor 10.

FIG. 7 is a diagram schematically illustrating a relationship between the center position of the projection image of reference sphere 18 in transmission wavefront measurement unit 3 and the reference position of transmission wavefront measurement unit 3 in the relative position adjustment method for lens measurement device 1 according to the exemplary embodiment of the present disclosure. In image 23 measured by wavefront sensor 10, a portion where parallel light 11 is transmitted through opening 19 of relative position adjustment jig 17 is represented as a bright image, and a portion where parallel light 11 is not transmitted is represented as a dark image. Since relative position adjustment jig 17 illustrated in FIG. 2 is used in the present exemplary embodiment, in image 23 measured by wavefront sensor 10, bright portion 24 because of opening 19 through which parallel light 11 is transmitted, projection image 25 of reference sphere 18, projection images 26, 27, and 28 of the support rods, and remaining dark portion 29 are displayed as dark portions.

The coordinate system of lens measurement device 1 is set to x, y, and z axes, and the coordinate system of image 23 measured by wavefront sensor 10 of transmission wavefront measurement unit 3 is set to H_w and V_w axes. To simplify the description, the x axis and the H_w axis, and the y axis and the V_w axis are oriented in the same direction. The origin position of transmission wavefront measurement unit 3 is defined as O_w. The center position of projection image 25 of reference sphere 18 described above is obtained as an amount of shift from origin position O_w of transmission wavefront measurement unit 3. The center position of projection image 25 of reference sphere 18 at this time is expressed as coordinates (ΔH_w, ΔV_w) of the coordinate system of transmission wavefront measurement unit 3.

The center position of projection image 25 of reference sphere 18 can be obtained by a general image processing technique. For example, a contour obtained by removing projection images 26, 27, and 28 of support rods 20, 21, and 22 from projection image 25 of reference sphere 18 is extracted, and the center when the contour is fitted to a circle may be set as the center position of projection image 25 of reference sphere 18. In addition, the center position of projection image 25 of reference sphere 18 can be accurately obtained by applying a filter of image processing such as smoothing to remove noise and the like included in projection image 25 of reference sphere 18.

Here, when the center position of projection image 25 of reference sphere 18 at the reference position of transmission wavefront measurement unit 3 is set as the coordinates (Xw, Yw) in the coordinate system of lens measurement device 1, the coordinates (Xow, Yow) in the coordinate system of lens measurement device 1 at origin position O_w of transmission wavefront measurement unit 3 can be expressed by Formulas (3) and (4).

$$Xow = Xw - ΔH\_w \qquad ( 3 )$$

$$Yow = Yw - ΔV\_w \qquad ( 4 )$$

Finally, in step S106, the relative position between shape measurement unit 2 and transmission wavefront measurement unit 3 is calculated by calculation unit 14.

The relative position between shape measurement unit 2 and transmission wavefront measurement unit 3 can be obtained by calculation unit 14 from the center position of reference sphere 18 and the center position of the projection image of reference sphere 18, that is, from the difference between the coordinates (Xof, Yof) of origin position O_f of shape measurement unit 2 in the coordinate system of lens measurement device 1 and the coordinates (Xow, Yow) of origin position O_w of transmission wavefront measurement unit 3 in the coordinate system of lens measurement device 1. The relative position (AX, AY) between shape measurement unit 2 and transmission wavefront measurement unit 3 with respect to shape measurement unit 2 can be expressed by Formulas (5) and (6) from Formulas (1), (2), (3), and (4).

$$Δ X = Xow - Xof \qquad ( 5 )$$

$$Δ Y = Yow - Yof \qquad ( 6 )$$

When further developed, the relative position can be expressed by Formulas (7) and (8).

$$Δ X = ( Xw - Xf ) - ΔH - w + ΔH\_f \qquad ( 7 )$$

$$Δ Y = ( Yw - Yf ) - ΔV\_w + ΔV\_f \qquad ( 8 )$$

Here, (Xw−Xf) and (Yw−Yf) of the first item on the right side of Formulas (7) and (8) can be accurately obtained as the movement amount from the predetermined reference position of shape measurement unit 2 to the predetermined reference position of transmission wavefront measurement unit 3 with transfer unit 7. ΔH_w and ΔV_w in the second item can be obtained from the center position of reference sphere 18 as described above, and ΔH_f and ΔV_f in the third item can be obtained from the center position of projection image 25 of reference sphere 18 as described above.

In this manner, the relative position between shape measurement unit 2 and transmission wavefront measurement unit 3 can be calculated with high accuracy using relative position adjustment jig 17.

Calculation unit 14 illustrated in FIG. 1 performs the above calculation to obtain the relative position between shape measurement unit 2 and transmission wavefront measurement unit 3, and the relative position is stored in relative position storage 16.

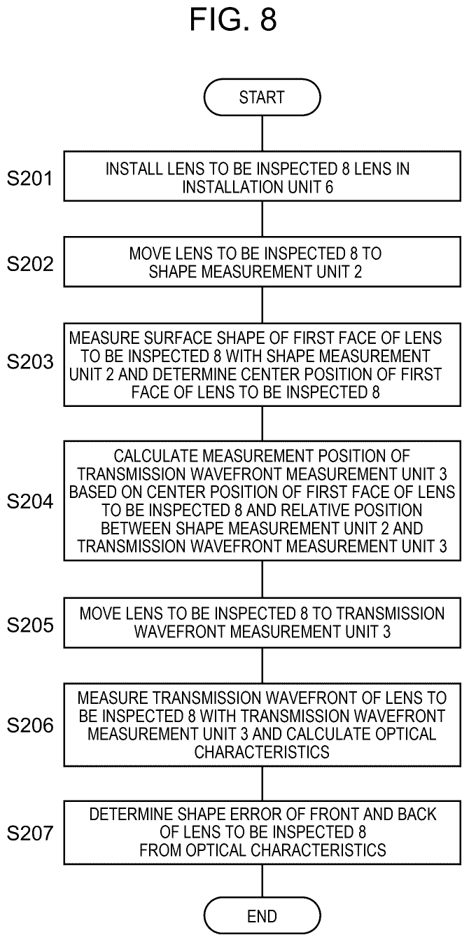

Next, a lens measurement method according to the exemplary embodiment of the present disclosure will be described with reference to the flowchart of FIG. 8. FIG. 8 is a flowchart describing a lens measurement method with lens measurement device 1 according to the exemplary embodiment of the present disclosure.

First, in step S201, lens to be inspected 8 is installed in lens installation unit 6.

Next, in step S202, lens to be inspected 8 installed in lens installation unit 6 is moved to shape measurement unit 2 by transfer unit 7 under the control of controller 15. That is, in the present exemplary embodiment, in lens measurement device 1 of FIG. 1, lens to be inspected 8 is positioned at a predetermined measurement position of shape measurement unit 2 by transfer unit 7 under the control of controller 15.

Next, in step S203, the surface shape of first face 8a of lens to be inspected 8 is measured by shape measurement unit 2, and the center position of first face 8a of lens to be inspected 8 is determined by shape measurement calculation unit 12 based on the measurement result.

In the present exemplary embodiment, in lens measurement device 1 of FIG. 1, surface 8a of the lens to be inspected 8 facing the direction of measurement probe 5 (the positive direction of the z axis) is defined as the first face of lens to be inspected 8. The surface shape of first face 8a of lens to be inspected 8 is scanned and measured by measurement probe 5. In the present exemplary embodiment, shape measurement calculation unit 12 obtains the vertex position of first face 8a of lens to be inspected 8 in the z-axis direction as the center position of first face 8a of lens to be inspected 8. The vertex position of first face 8a of lens to be inspected 8 in the z-axis direction can be obtained by, for example, measuring a section of first face 8a of lens to be inspected 8 in any x-axis direction with measurement probe 5 to obtain an x-coordinate at which the vertex comes in the z-axis direction, measuring a section of first face 8a of lens to be inspected 8 in any y-axis direction to obtain a y-coordinate at which the vertex comes in the z-axis direction, whereby shape measurement calculation unit 12 obtains the x and y coordinates of the center position of first face 8a of lens to be inspected 8.

In the present exemplary embodiment, as in lens to be inspected 8 illustrated in FIG. 1, a lens in which first face 8a of lens to be inspected 8 is convex in the positive direction of the z axis has been described as an example. When first face 8a of lens to be inspected 8 is concave in the negative direction of the z axis, a position where a vertex comes in the z axis direction in the negative direction may be obtained, and x and y coordinates of the center position may be obtained by shape measurement calculation unit 12.

A method may be employed in which the vicinity of the vertex of first face 8a of lens to be inspected 8 is scanned on the xy-axis plane at equal intervals, and coordinates that become the vertex in the positive or negative direction of the z axis are obtained by shape measurement calculation unit 12.

When lens to be inspected 8 has a complicated aspherical shape, shape measurement calculation unit 12 may obtain the center position of the aspherical shape by fitting the measured surface shape of first face 8a of lens to be inspected 8 and the aspherical data defined by the design value to obtain the center position of the aspherical shape as the center position of first face 8a of lens to be inspected 8. By adopting such a method, the center position of first face 8a of lens to be inspected 8 can be accurately obtained by shape measurement calculation unit 12 even though the lens does not have a vertex in the positive or negative direction of the z axis at the center position of first face 8a of lens to be inspected 8.

Next, in step S204, the measurement position of transmission wavefront measurement unit 3 is calculated by calculation unit 14 based on the center position of first face 8a of lens to be inspected 8 and the relative position between shape measurement unit 2 and transmission wavefront measurement unit 3.

In the present exemplary embodiment, the center position of first face 8a of lens to be inspected 8 is obtained as an amount of shift from the origin position of shape measurement unit 2. At this time, the amount of shift of the center position of first face 8a of lens to be inspected 8 from the origin position of shape measurement unit 2 is represented as (ΔX_fL, ΔY_fL). The coordinates of the predetermined measurement position of shape measurement unit 2 of transfer unit 7 are expressed as (X_fm, Y_fm). Since the relative position (ΔX, ΔY) between shape measurement unit 2 and transmission wavefront measurement unit 3 stored in relative position storage 16 obtained in the flowchart of the relative position adjustment method in FIG. 3 is a difference of the origin position of transmission wavefront measurement unit 3 with respect to the origin position of shape measurement unit 2, the coordinates (X_wm, Y_wm) of the measurement position of transmission wavefront measurement unit 3 of transfer unit 7 where the origin position of transmission wavefront measurement unit 3 coincides with the center position of first face 8a of lens to be inspected 8 in transmission wavefront measurement unit 3 can be expressed by Formulas (9) and (10).

$$X\_wm = X\_fm + Δ X - ΔX\_fL \qquad ( 9 )$$

$$Y\_wm = Y\_fm + Δ Y - ΔY\_fL \qquad ( 10 )$$

In this manner, the measurement position of transmission wavefront measurement unit 3 can be calculated with calculation unit 14.

Next, in step S205, lens to be inspected 8 is moved to transmission wavefront measurement unit 3 by transfer unit 7 under the control of controller 15.

That is, in the present exemplary embodiment, lens to be inspected 8 is moved to the coordinates of the measurement position of transmission wavefront measurement unit 3 calculated in step S204 by transfer unit 7 under the control of controller 15, whereby the origin position of transmission wavefront measurement unit 3 and the center position of first face 8a of lens to be inspected 8 are positioned to coincide with each other.

Next, in step S206, the transmission wavefront of lens to be inspected 8 is measured by transmission wavefront measurement unit 3, the transmission wavefront is calculated by transmission wavefront measurement calculation unit 13, and the optical characteristics are calculated by calculation unit 14 based on the calculation result.

That is, in the present exemplary embodiment, in lens measurement device 1 of FIG. 1, parallel light 11 is emitted from light source 9, the light transmitted through lens to be inspected 8 is received by wavefront sensor 10, and the transmission wavefront is measured. Transmission wavefront measurement calculation unit 13 fits the measured phase distribution of the transmission wavefront with the Zernike polynomials and calculates a Zernike coefficient. Thus, the aberration coefficient that is information of the optical characteristics of lens to be inspected 8 can be obtained.

Here, an effect of positioning such that the origin position of transmission wavefront measurement unit 3 coincides with the center position of first face 8a of lens to be inspected 8 in step S205 will be described. To accurately measure the optical characteristics of lens to be inspected 8, it is necessary to accurately match the optical axis of ideal lens to be inspected 8 having no shape error with the center of the analysis circle for analyzing the transmission wavefront with the Zernike polynomials. Of the aberration coefficients of optical characteristics to be calculated, coma aberration, in particular, causes a large error with a shift of the center of the analysis circle. As described in the present exemplary embodiment, by positioning lens to be inspected 8 with transfer unit 7 such that the origin position of transmission wavefront measurement unit 3 coincides with the center position of first face 8a of lens to be inspected 8 taking the center position of first face 8a of lens to be inspected 8 as the optical axis of ideal lens to be inspected 8, it is possible to accurately match the optical axis of ideal lens to be inspected 8 without shape error with the center of the analysis circle, and it is possible to obtain the optical characteristics of lens to be inspected 8 with high accuracy.

In the present exemplary embodiment, additional optical components are not disposed between lens to be inspected 8 and wavefront sensor 10. This is because when additional optical components are disposed between lens to be inspected 8 and wavefront sensor 10, the measurement accuracy decreases because of the influence of an error in the optical characteristics of these optical components or an error in alignment. As a result, there is an effect that the optical characteristics of lens to be inspected 8 can be obtained with high accuracy.

In the present exemplary embodiment, unlike the conventional technique, the surface shape of the second face of lens to be inspected 8 is not measured with shape measurement unit 2, but the transmission wavefront of lens to be inspected 8 is measured with transmission wavefront measurement unit 3. In the transmission wavefront measurement, scanning with measurement probe 5 as in the shape measurement is unnecessary, and thus, the measurement time can be shortened. Thus, as compared with the conventional technique, the shape measurement requiring measurement time can be reduced to one time, and the lens measurement time can be shortened.

In the present exemplary embodiment, unlike the conventional technique, it is not necessary to vertically invert lens to be inspected 8 to measure the surface shapes of the first face and the second face of lens to be inspected 8. Thus, the step of vertically inverting lens to be inspected 8 can be omitted, and the lens measurement time can be shortened.

Finally, in step S207, the shape error of the front and back of lens to be inspected 8 is determined by calculation unit 14 from the optical characteristics.

That is, in the present exemplary embodiment, determination of the shape error of the front and back of lens to be inspected 8 is performed by calculation unit 14 using the correlation between the shape error and the optical characteristics. For example, determination of the error in the curvature radius of the surface shape of lens to be inspected 8 is performed by calculation unit 14 using the defocus of the aberration coefficient or the correlation with the spherical aberration. The amount of shift between the center of first face 8a of lens to be inspected 8 and the center of the second face in an in-plane direction (the xy-axis plane in FIG. 1) is determined by calculation unit 14 using the correlation between the aberration coefficient and coma aberration. The correlation between each shape error and the optical characteristics may be obtained in advance from a measurement result of simulation or a preliminary experiment. The result of the optical characteristics obtained with high accuracy in step S206 is calculated by calculation unit 14 using the correlation between the shape error and the optical characteristics obtained in advance, whereby the shape error of lens to be inspected 8 can be determined by calculation unit 14.

Determination of the shape error may be performed by calculation unit 14 in combination with the measurement result of the surface shape of first face 8a of lens to be inspected 8 measured by shape measurement unit 2. For example, optical simulation is performed by calculation unit 14 based on the measurement result of the surface shape of first face 8a of lens to be inspected 8, and the optical simulation is compared with the result of the optical characteristics obtained with high accuracy in step S206, whereby the shape error of the second face of lens to be inspected 8 can be determined with higher accuracy.

Determination of the shape error can be performed by calculation unit 14 in combination with the result of measuring lens to be inspected 8 by a device other than lens measurement device 1. For example, calculation unit 14 performs optical simulation based on the result of measuring the thickness of lens to be inspected 8 and compares the result with the result of the optical characteristics obtained with high accuracy in step S206, whereby the error in the curvature radius of the surface shape of lens to be inspected 8 can be determined with higher accuracy.

By performing the lens measurement method as described above, the optical characteristics, and further, the shape error of lens to be inspected 8 can be measured with high accuracy with a shortened measurement time.

In FIGS. 2, 4, and 6, reference sphere 18 of relative position adjustment jig 17 is illustrated as a complete sphere as an example of the reference sphere unit, but the reference sphere unit does not have to be a complete sphere. For example, as another example of the reference sphere unit, the shape of reference sphere may be the shape of reference sphere 18 with which the shape of reference sphere 18 of relative position adjustment jig 17 can be measured with measurement probe 5 to calculate the center position of reference sphere 18 in shape measurement unit 2 in step S103, and at the same time, the shape of reference sphere 18 with which the center position of the projection image of reference sphere 18 of relative position adjustment jig 17 can be calculated in transmission wavefront measurement unit 3 in step S105 in the flowchart of the relative position adjustment method in FIG. 3. Specifically, reference sphere 18 of relative position adjustment jig 17 may have a hemisphere in a surface area of more than or equal to 50%, and the hemisphere of reference sphere 18 of relative position adjustment jig 17 may be disposed on measurement probe 5 side of shape measurement unit 2. With such a shape of reference sphere 18, reference sphere 18 can be easily fixed to relative position adjustment jig 17, and relative position adjustment jig 17 can be realized at low cost.

In lens measurement device 1 of FIG. 1, an example in which lens installation unit 6 is detachably mounted on transfer unit 7 is illustrated, but lens installation unit 6 may be fixed to transfer unit 7.

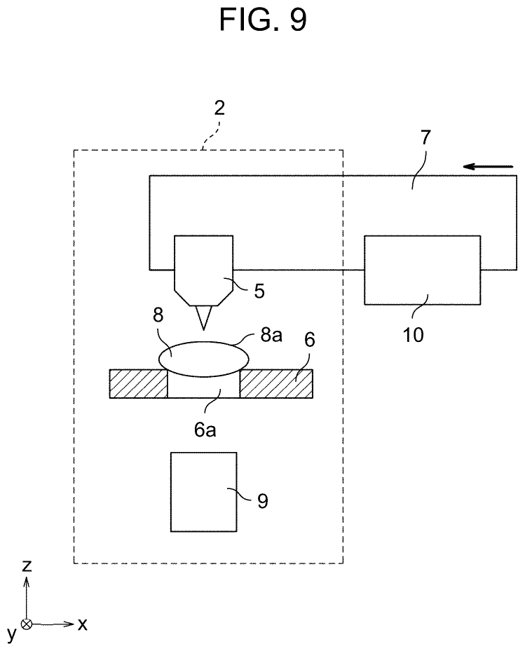

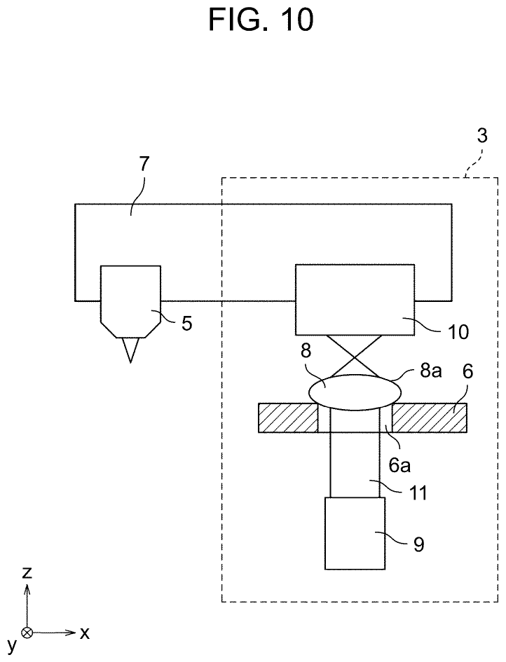

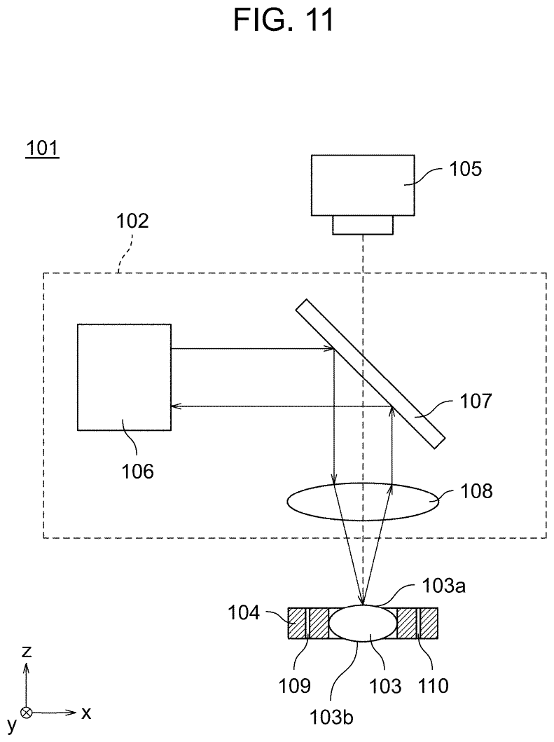

FIG. 9 is a diagram schematically illustrating lens measurement device 1A according to a modification of the exemplary embodiment of the present disclosure. The difference in configuration from FIG. 1 is that measurement probe 5 and wavefront sensor 10 are mounted on transfer unit 7 so as to be movable. Lens installation unit 6 is fixed to, for example, a measurement device installation base of lens measurement device 1A separately from transfer unit 7, and lens to be inspected 8 is installed in lens installation unit 6. In addition, light source 9 is disposed below lens installation unit 6 while being fixed to, for example, a measurement device installation base. Thus, when measurement probe 5 is moved and positioned so as to face lens installation unit 6 by transfer unit 7, measurement probe 5 functions as shape measurement unit 2 (see FIG. 9), and when wavefront sensor 10 is moved and positioned so as to face lens installation unit 6 by transfer unit 7, wavefront sensor 10 functions as transmission wavefront measurement unit 3 (see FIG. 10).

FIG. 9 illustrates a state in which the position of lens installation unit 6 functions as shape measurement unit 2, measurement probe 5 is positioned at the measurement position of lens installation unit 6 by transfer unit 7, and the surface shape of first face 8a of lens to be inspected 8 is measured by measurement probe 5. At this time, light source 9 does not emit light.

FIG. 10 is a diagram schematically illustrating lens measurement device 1A according to a modification of the embodiment of the present disclosure at the time of transmission wavefront measurement of the lens measurement device. FIG. 10 illustrates a state in which the position of lens installation unit 6 functions as transmission wavefront measurement unit 3. Wavefront sensor 10 is positioned at the measurement position of lens installation unit 6 by transfer unit 7, parallel light 11 is emitted from light source 9, the light transmitted through lens to be inspected 8 is received by wavefront sensor 10, whereby the transmission wavefront is measured.

The relative position between measurement probe 5 mounted on transfer unit 7 and wavefront sensor 10 is determined by the same method as the relative position adjustment method for lens measurement device 1 illustrated in FIG. 3 using relative position adjustment jig 17.

The measurement of lens to be inspected 8 is performed by the same method as the lens measurement method for lens measurement device 1 illustrated in FIG. 8.

With the above configuration, it is possible to prevent positional shift of lens to be inspected 8 caused by vibration or the like at the time of transferring lens to be inspected 8, and lens to be inspected 8 can be measured with high accuracy.

Various aspects of the present disclosure will be described below.

In a first aspect of the present disclosure,
a lens measurement method using a shape measurement unit that measures a surface shape of a lens and a transmission wavefront measurement unit that measures a transmission wavefront of the lens, the method including:
measuring a surface shape of a first face of the lens with the shape measurement unit to determine a center position of the first face of the lens from a result of the measuring of the surface shape;
positioning the lens in the transmission wavefront measurement unit based on the center position of the first face of the lens and a relative position between the shape measurement unit and the transmission wavefront measurement unit;
measuring the transmission wavefront of the lens with the transmission wavefront measurement unit; and
obtaining an optical characteristic of the lens from a result of the measuring of the transmission wavefront.

In a second aspect of the present disclosure,
the lens measurement method according to the first aspect, in which
the relative position is determined by:
obtaining a center position of a reference sphere unit of a relative position adjustment jig by measuring the reference sphere unit in the shape measurement unit, the relative position adjustment jig including the reference sphere unit and a light transmission unit that transmits light around the reference sphere unit;
obtaining a center position of a projection image of the reference sphere unit by measuring the reference sphere unit of the relative position adjustment jig in the transmission wavefront measurement unit; and
determining the relative position between the shape measurement unit and the transmission wavefront measurement unit from the center position of the reference sphere unit and the center position of the projection image of the reference sphere unit.

In a third aspect of the present disclosure,
the lens measurement method according to the first or second aspect, further including,
after obtaining the optical characteristic of the lens, determining a shape error of a front and back of the lens from the optical characteristic of the lens.

In a fourth aspect of the present disclosure,
the lens measurement method according to any one of the first to third aspects, in which
the transmission wavefront measurement unit includes a light source of parallel light and a wavefront sensor that measures a phase distribution of a wavefront of light from the light source, and
the lens measurement method includes, when measuring the transmission wavefront, causing the light from the light source to be directly incident on the lens, causing the light transmitted through the lens to be directly incident on the wavefront sensor, and measuring the transmission wavefront with the wavefront sensor.

In a fifth aspect of the present disclosure,
a lens measurement device including:
a shape measurement unit that measures a surface shape of a first face of a lens;
a shape measurement calculation unit that determines a center position of the first face of the lens from a measurement result in the shape measurement unit;
a transmission wavefront measurement unit that measures a transmission wavefront of the lens that has been positioned based on a relative position with the shape measurement unit and the center position of the first face of the lens; and
a calculation unit that obtains an optical characteristic of the lens from a result of measuring the transmission wavefront of the lens with the transmission wavefront measurement unit.

In a sixth aspect of the present disclosure,
the lens measurement device according to the fifth aspect, further including:
a lens installation unit that installs the lens in each of the shape measurement unit and the transmission wavefront measurement unit;
a relative position adjustment jig configured to be installed in the lens installation unit instead of the lens, the relative position adjustment jig including
   a reference sphere unit for determining a relative position between the shape measurement unit and the transmission wavefront measurement unit and
   a light transmission unit that transmits light around the reference sphere unit;
a relative position storage that stores the relative position between the shape measurement unit and the transmission wavefront measurement unit determined from a center position of the reference sphere unit obtained by measuring the reference sphere unit of the relative position adjustment jig in the shape measurement unit and a center position of a projection image of the reference sphere unit obtained by measuring the reference sphere unit of the relative position adjustment jig in the transmission wavefront measurement unit; and
a controller that adjusts positions of the shape measurement unit and the transmission wavefront measurement unit with respect to the lens installation unit,
in which
the calculation unit calculates an installation position of the lens in the transmission wavefront measurement unit from the center position of the first face of the lens measured in the shape measurement unit and the relative position stored in the relative position storage, and
the transmission wavefront measurement unit includes a light source of parallel light and a wavefront sensor that measures a phase distribution of a wavefront of light from the light source, the light from the light source is directly incident on the lens, the light transmitted through the lens is directly incident on the wavefront sensor, and the transmission wavefront is measured with the wavefront sensor.

In a seventh aspect of the present disclosure,
the lens measurement device according to the sixth aspect, in which
the reference spherical unit of the relative position adjustment jig has a diameter smaller than each of a vertical dimension and a horizontal dimension of an image sensor of the wavefront sensor of the transmission wavefront measurement unit.

In an eighth aspect of the present disclosure,
the lens measurement device according to the sixth or seventh aspect, in which
the reference sphere unit of the relative position adjustment jig includes a hemisphere in a surface area of more than or equal to 50%, and the hemisphere of the reference sphere unit of the relative position adjustment jig is disposed on a measurement probe side of the shape measurement unit.

In a ninth aspect of the present disclosure,
the lens measurement device according to any one of the sixth to eighth aspects, in which
the light source of the transmission wavefront measurement unit and the lens installation unit are fixed,
a measurement probe of the shape measurement unit and the wavefront sensor of the transmission wavefront measurement unit are installed in a same transfer unit,
when the measurement probe functions as the shape measurement unit, the measurement probe is moved by the same transfer unit to face the lens installation unit, and
when the wavefront sensor functions as the transmission wavefront measurement unit, the wavefront sensor is moved by the same transfer unit to face the lens installation unit.

Any appropriate combination of the various exemplary embodiments or modifications described above enables effects of the respective exemplary embodiments or modifications to be achieved. Combinations of exemplary embodiments, combinations of examples, or combinations of exemplary embodiments and examples are possible, and combinations of features in different exemplary embodiments or examples are also possible.

According to the present disclosure, the time for measuring optical characteristics such as the wavefront aberration of a lens can be shortened by performing shape measurement of only one face of the lens and eliminating the need for vertical inversion.

### INDUSTRIAL APPLICABILITY

The lens measurement method and the lens measurement device of the present disclosure can shorten the time for measuring the optical characteristics such as the wavefront aberration of a lens, and are useful for measurement, adjustment, test, or inspection in the manufacturing process of a single lens or an assembled lens.

### REFERENCE MARKS IN THE DRAWINGS

1, 1A lens measurement device
2 shape measurement unit
3 transmission wavefront measurement unit
4 control device
5 measurement probe
6 lens installation unit
6a opening
7 transfer unit
8 lens to be inspected
8a first face
9 light source
10 wavefront sensor
11 parallel light
12 shape measurement calculation unit
13 transmission wavefront measurement calculation unit
14 calculation unit
15 controller
16 relative position storage
17 relative position adjustment jig
18 reference sphere
19 opening
20 support rod
21 support rod
22 support rod
23 image measured with wavefront sensor
24 bright portion
25 projection image of reference sphere
26 projection image of support rod
27 projection image of support rod
28 projection image of support rod
29 remaining dark portion
101 lens measurement device
102 optical probe
103 lens to be inspected
104 lens installation jig
105 camera
106 sensor unit
107 reflection mirror
108 objective lens
109 pinhole
110 pinhole

1. A lens measurement method using a shape measurement unit that measures a surface shape of a lens and a transmission wavefront measurement unit that measures a transmission wavefront of the lens, the method comprising:
measuring a surface shape of a first face of the lens with the shape measurement unit to determine a center position of the first face of the lens from a result of the measuring of the surface shape;
positioning the lens in the transmission wavefront measurement unit based on the center position of the first face of the lens and a relative position between the shape measurement unit and the transmission wavefront measurement unit;
measuring the transmission wavefront of the lens with the transmission wavefront measurement unit; and
obtaining an optical characteristic of the lens from a result of the measuring of the transmission wavefront.

2. The lens measurement method according to claim 1, wherein
the relative position is determined by:
obtaining a center position of a reference sphere of a relative position adjustment jig by measuring the reference sphere in the shape measurement unit, the relative position adjustment jig including the reference sphere and a light transmission unit that transmits light around the reference sphere;
obtaining a center position of a projection image of the reference sphere by measuring the reference sphere of the relative position adjustment jig in the transmission wavefront measurement unit; and
determining the relative position between the shape measurement unit and the transmission wavefront measurement unit from the center position of the reference sphere and the center position of the projection image of the reference sphere.

3. The lens measurement method according to claim 1, further comprising,
after obtaining the optical characteristic of the lens, determining a shape error of a front and back of the lens from the optical characteristic of the lens.

4. The lens measurement method according to claim 1, wherein
the transmission wavefront measurement unit includes a light source of parallel light and a wavefront sensor that measures a phase distribution of a wavefront of light from the light source, and
the lens measurement method includes, when measuring the transmission wavefront, causing the light from the light source to be directly incident on the lens, causing the light transmitted through the lens to be directly incident on the wavefront sensor, and measuring the transmission wavefront with the wavefront sensor.

5. A lens measurement device comprising:
a shape measurement unit that measures a surface shape of a first face of a lens;
a shape measurement calculation unit that determines a center position of the first face of the lens from a measurement result in the shape measurement unit;
a transmission wavefront measurement unit that measures a transmission wavefront of the lens that has been positioned based on a relative position with the shape measurement unit and the center position of the first face of the lens; and
a calculation unit that obtains an optical characteristic of the lens from a result of measuring the transmission wavefront of the lens with the transmission wavefront measurement unit.

6. The lens measurement device according to claim 5, further comprising:
a lens installation unit that installs the lens in each of the shape measurement unit and the transmission wavefront measurement unit;
a relative position adjustment jig configured to be installed in the lens installation unit instead of the lens, the relative position adjustment jig including
a reference sphere for determining a relative position between the shape measurement unit and the transmission wavefront measurement unit and
a light transmission unit that transmits light around the reference sphere;
a relative position storage that stores the relative position between the shape measurement unit and the transmission wavefront measurement unit determined from a center position of the reference sphere obtained by measuring the reference sphere of the relative position adjustment jig in the shape measurement unit and a center position of a projection image of the reference sphere obtained by measuring the reference sphere of the relative position adjustment jig in the transmission wavefront measurement unit; and
a controller that adjusts positions of the shape measurement unit and the transmission wavefront measurement unit with respect to the lens installation unit,
wherein
the calculation unit calculates an installation position of the lens in the transmission wavefront measurement unit from the center position of the first face of the lens measured in the shape measurement unit and the relative position stored in the relative position storage, and
the transmission wavefront measurement unit includes a light source of parallel light and a wavefront sensor that measures a phase distribution of a wavefront of light from the light source, the light from the light source is directly incident on the lens, the light transmitted through the lens is directly incident on the wavefront sensor, and the transmission wavefront is measured with the wavefront sensor.

7. The lens measurement device according to claim 6, wherein
the reference spherical unit of the relative position adjustment jig has a diameter smaller than each of a vertical dimension and a horizontal dimension of an image sensor of the wavefront sensor of the transmission wavefront measurement unit.

8. The lens measurement device according to claim 6, wherein
the reference sphere of the relative position adjustment jig includes a hemisphere in a surface area of more than or equal to 50%, and the hemisphere of the reference sphere of the relative position adjustment jig is disposed on a measurement probe side of the shape measurement unit.

9. The lens measurement device according to claim 6, wherein
the light source of the transmission wavefront measurement unit and the lens installation unit are fixed,
a measurement probe of the shape measurement unit and the wavefront sensor of the transmission wavefront measurement unit are installed in a same transfer unit,
when the measurement probe functions as the shape measurement unit, the measurement probe is moved by the same transfer unit to face the lens installation unit, and
when the wavefront sensor functions as the transmission wavefront measurement unit, the wavefront sensor is moved by the same transfer unit to face the lens installation unit.
